(19) United States
(12) Patent Application Publication
(10) Pub. No.: US 2004/0039562 A1
(43) Pub. Date: Feb. 26, 2004

(54) Para-linguistic expansion

(76) Inventor: Kenneth Haase, Dorchester, MA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/463,117

(22) Filed: Jun. 17, 2003

Related U.S. Application Data
(60) Provisional application No. 60/389,188, filed on Jun. 17, 2002.
(60) Provisional application No. 60/389,184, filed on Jun. 17, 2002.

(51) Int. Cl. G06F 17/20

(52) U.S. Cl. 704/1

(57) ABSTRACT

The present invention relates to systems and methods for databases. One embodiment of the invention provides a system for managing at least one data item. The system includes: a para-linguistic analyzer operative to receive search data and to identify a first keytuple included in the search data; a keytuple expander in communication with the para-linguistic analyzer and operative to generate a set of keytuples associated with the first keytuple; and an information retrieval engine in communication with the keytuple expander and operative to manage at least one data item based at least in part on the set of keytuples.

### CROSS REFERENCE TO RELATED APPLICATION

This document claims priority to, and the benefit of the filing date of, co-pending provisional application entitled “Para-Linguistic Query Expansion for Information Retrieval” assigned Ser. No. 60/389,188, filed Jun. 17, 2002, and which is hereby incorporated by reference in its entirety.

### BACKGROUND OF THE INVENTION

The present invention relates to systems and methods for improving the precision and recall of free text natural language queries against textual databases.

Retrieval of textual information for human beings or their intelligent agents is a hit-or-miss process attempting to match the information needs of a human user with the knowledge content of information items in a database. The chief complicating factor in this matchmaking is that information needs and knowledge content are based on concepts, meanings, and relations while the information items themselves and typically the descriptions of individual information needs are based on sequences of ambiguous words in a particular natural language. Most algorithms for textual information retrieval work by using statistical or probabilistic properties of large ensembles of text to attempt to extract meaning of words. In addition to the inherent errors of such approximations, these approaches suffer from their reliance on the actual word forms in the text. While nearly all of them generalize word forms through stemming (so that “chips” becomes “chip”), they do not typically expand “chip” to other base word forms that may have the same meaning. So “chip” is not extended to “integrated circuit” (in an electronics domain) or (ambiguously) to “crisp” or “french fry” (in the food domain), and “sample” (in the paint domain).

Some work has been done in this area, called query expansion, where textual queries are expanded by a thesaurus, so that a search for “chip” will find documents referring to french fries, crisps, integrated circuits, and samples. This assortment illustrates the problem with straightforward query expansion: it retrieves too many unrelated documents because it does not reflect the meaning of the word in its context in the original query.

The problem can be understood more formally in terms of two metrics commonly used to describe information retrieval performance: recall and precision. Recall is a measure of how many of the relevant documents were actually found by the algorithm; precision is a measure of how many of the documents found were actually relevant. Suppose we have a hundred documents of which 20 are relevant to a particular query. If an algorithm finds 15 of these 20 documents, it has a recall rate of 75%; if the algorithm also finds 10 irrelevant documents, it has a precision rate of 60%.

In these terms, query expansion increases the recall rate of the algorithm while decreasing the precision rate. In practical information retrieval contexts, lowered precision has a serious cost because a human expert has to sift through the erroneous results to filter out the actually relevant articles.

### Summary of the Invention

The present invention relates to systems and methods for improving the precision and/or recall of free text natural language queries against textual databases. Embodiments of the invention include: a background linguistic database capable of generating synonyms and other related terms; and a textual pre-processor capable of extracting para-linguistic word associations, e.g. pairs and triples, of words from natural language text.

Embodiments of the invention process the text to produce a “para-linguistic” representation where associations, e.g. pairs or triplets, of words (“keytuples”) represent probable linguistic relationships between words in the text. In one embodiment, this processing is applied to both the texts of the document base and to a query entered by a user or their agent. Texts or text fragments are then indexed using the keytuples in much the same way that traditional information retrieval systems index text via single keywords ,Embodiments of the invention expand elements of these para-linguistic compounds using the linguistic database.

When a query is processed for searching, query expansion is applied to the individual terms of generated keytuples to generate “extended keytuples”. Traditional information retrieval techniques are then applied to find documents whose keytuples match the extended keytuples derived from the query. These expansions are able to identify documents or fragments using synonymous words, but the combination of words into keytuples encodes part of the context, reducing the erroneous retrieval of documents based on other meanings of the expanded word.

Thus, embodiments of the invention use para-linguistic keytuples, rather than keywords, to provide for increased precision and contextualization of individual keyword appearances. In addition, embodiments of the invention combine query expansion with a keytuple representation to increase recall without decreasing precision.

### BRIEF DESCRIPTION OF THE ILLUSTRATED EMBODIMENTS

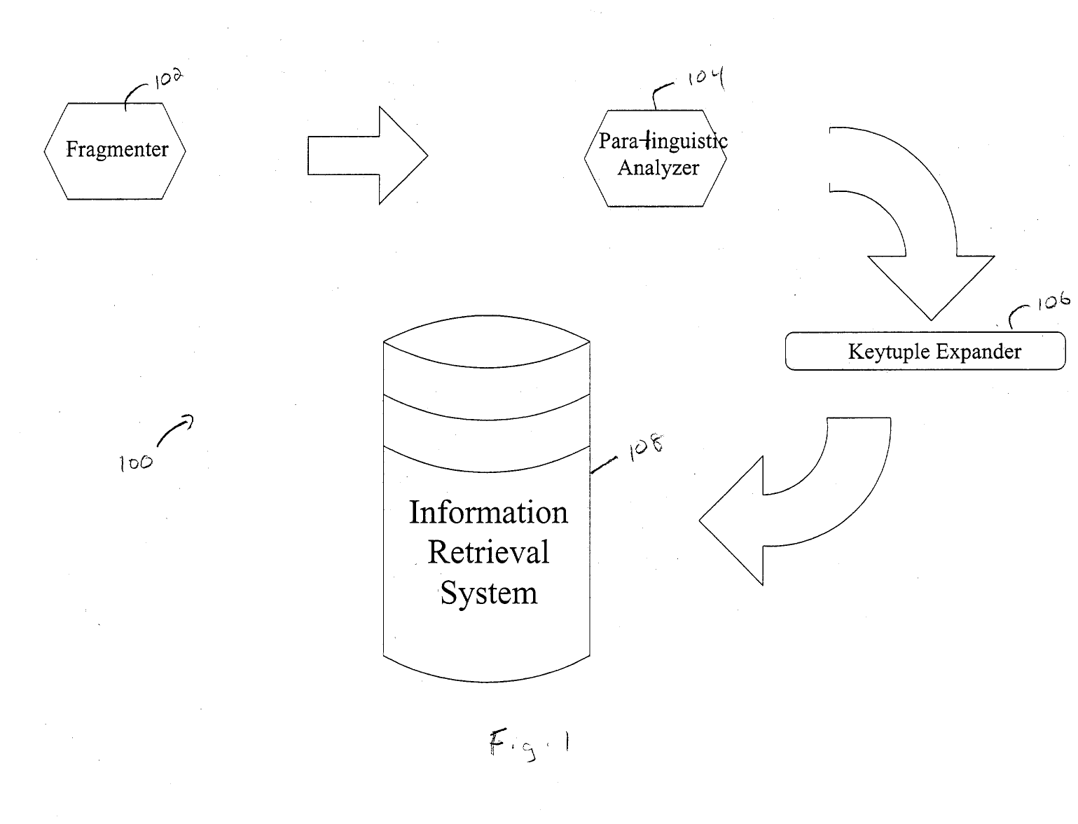

FIG. 1 is a schematic illustration of a system for achieving information retrieval according to one embodiment of the invention.

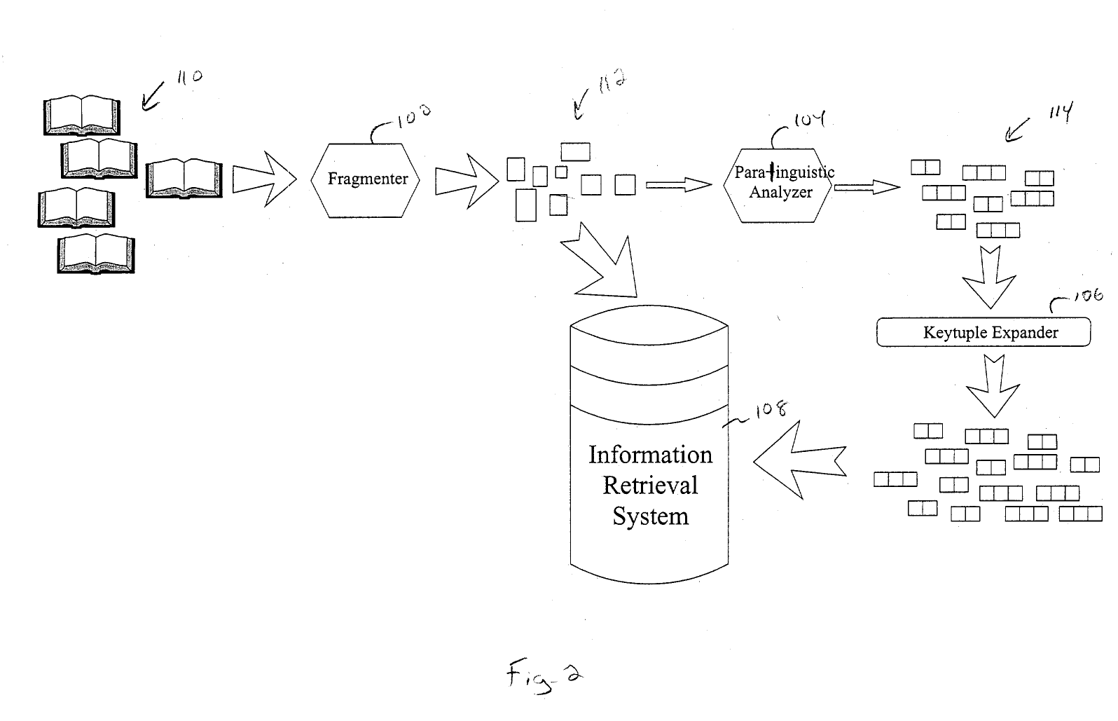

FIG. 2 is a schematic illustration of an indexing embodiment of the system of FIG. 1.

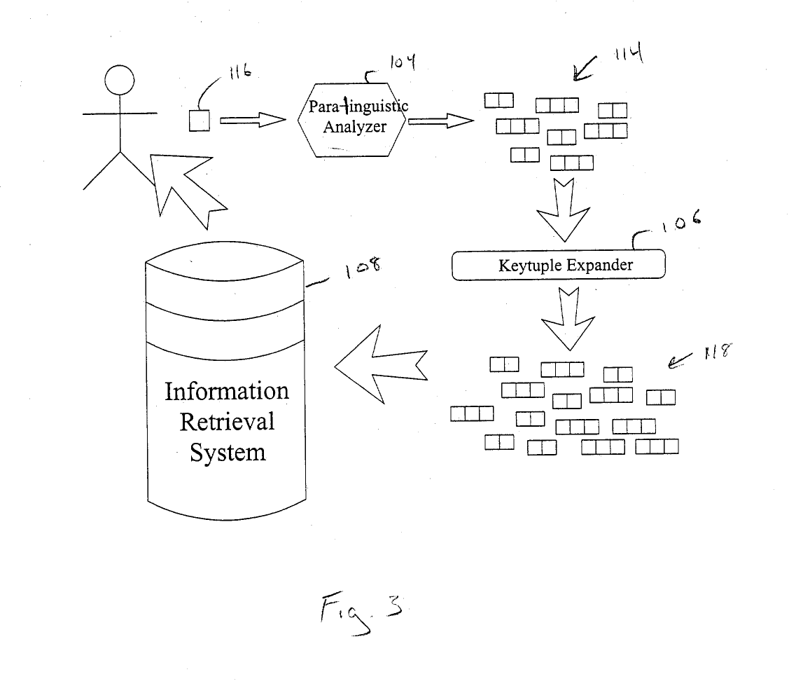

FIG. 3 is a schematic illustration of a search embodiment of the system of FIG. 1.

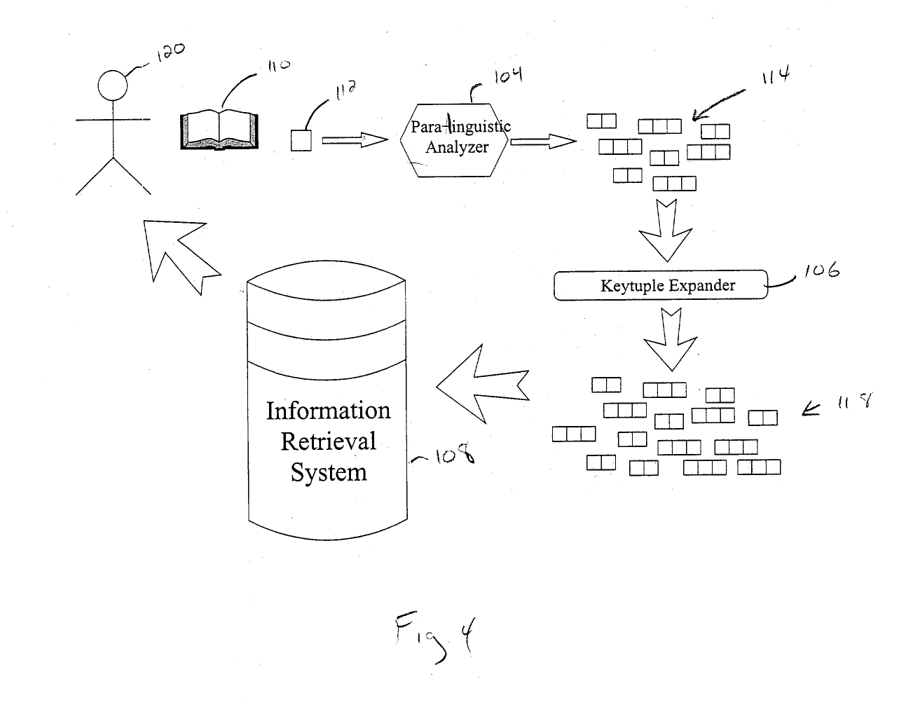

FIG. 4 is a schematic illustration of a similarity embodiment of the system of FIG. 1.

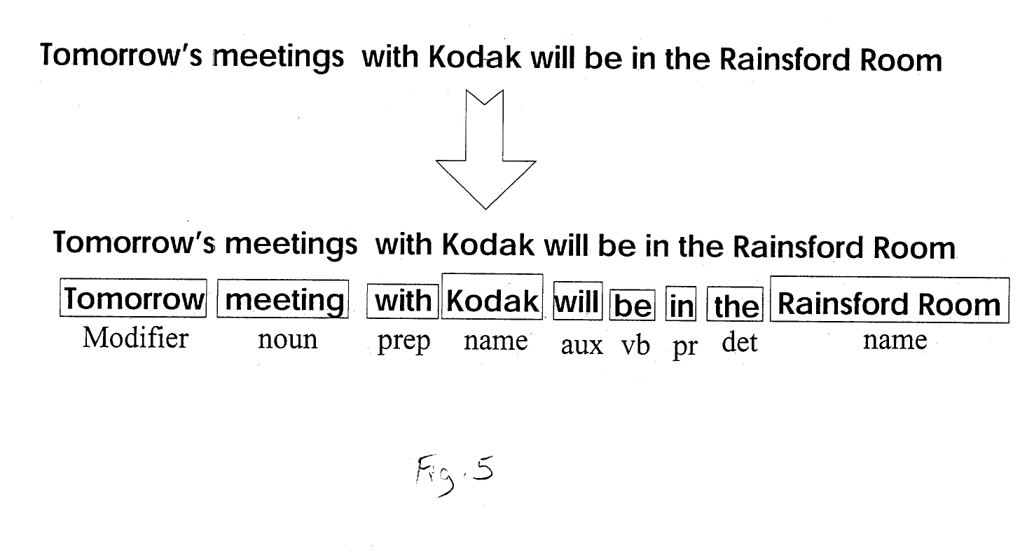

FIG. 5 is an illustration of part of the analysis performed by one embodiment of the para-linguistic analyzer of FIG. 1.

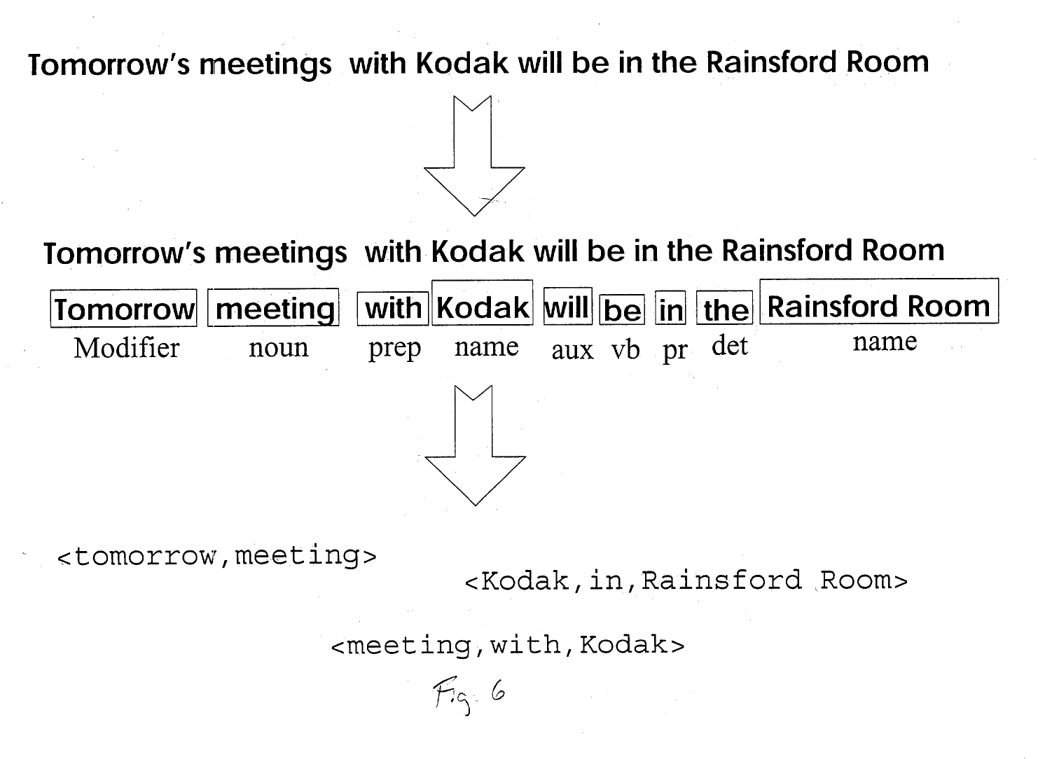

FIG. 6 is an illustration of additional analysis performed by one embodiment of the para-linguistic analyzer of FIG. 1.

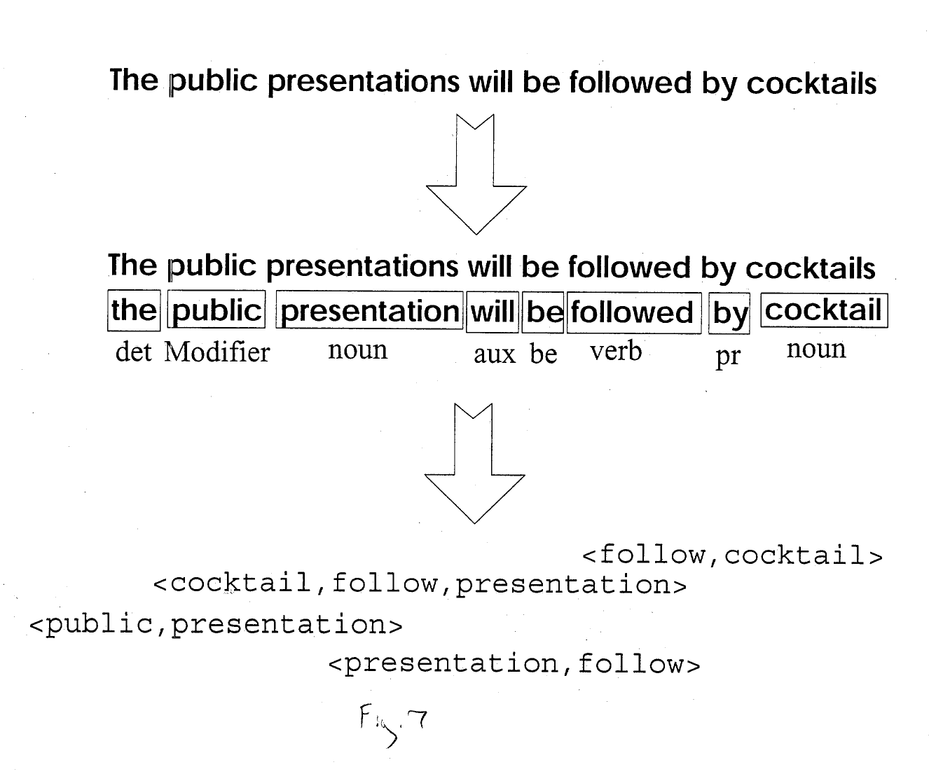

FIG. 7 is an illustration of an analysis performed by one embodiment of the para-linguistic analyzer of FIG. 1 in the context of an English sentence written in the passive voice.

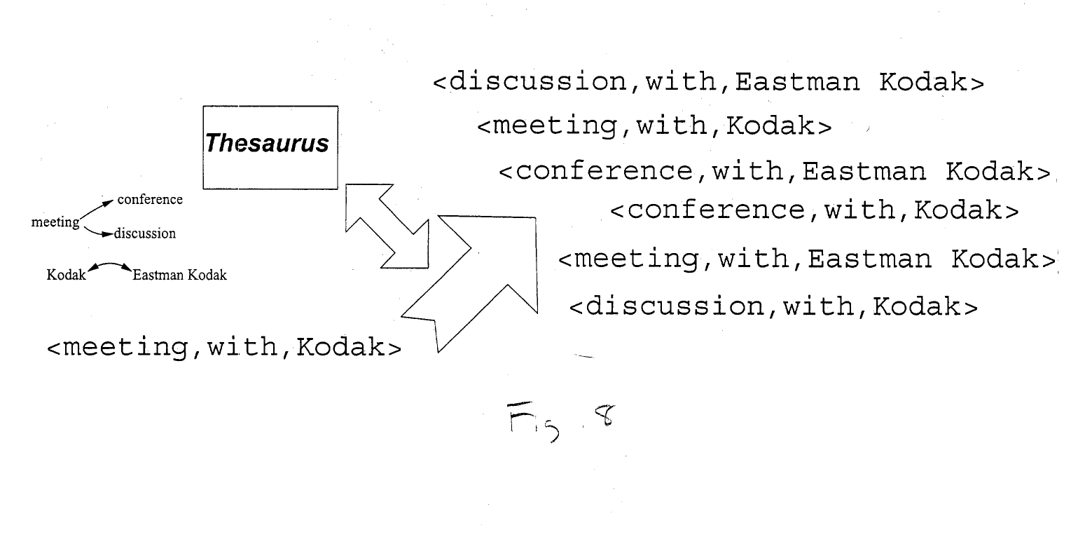

FIG. 8 is an illustration of operation of one embodiment of the keytuple expander of FIG. 1.

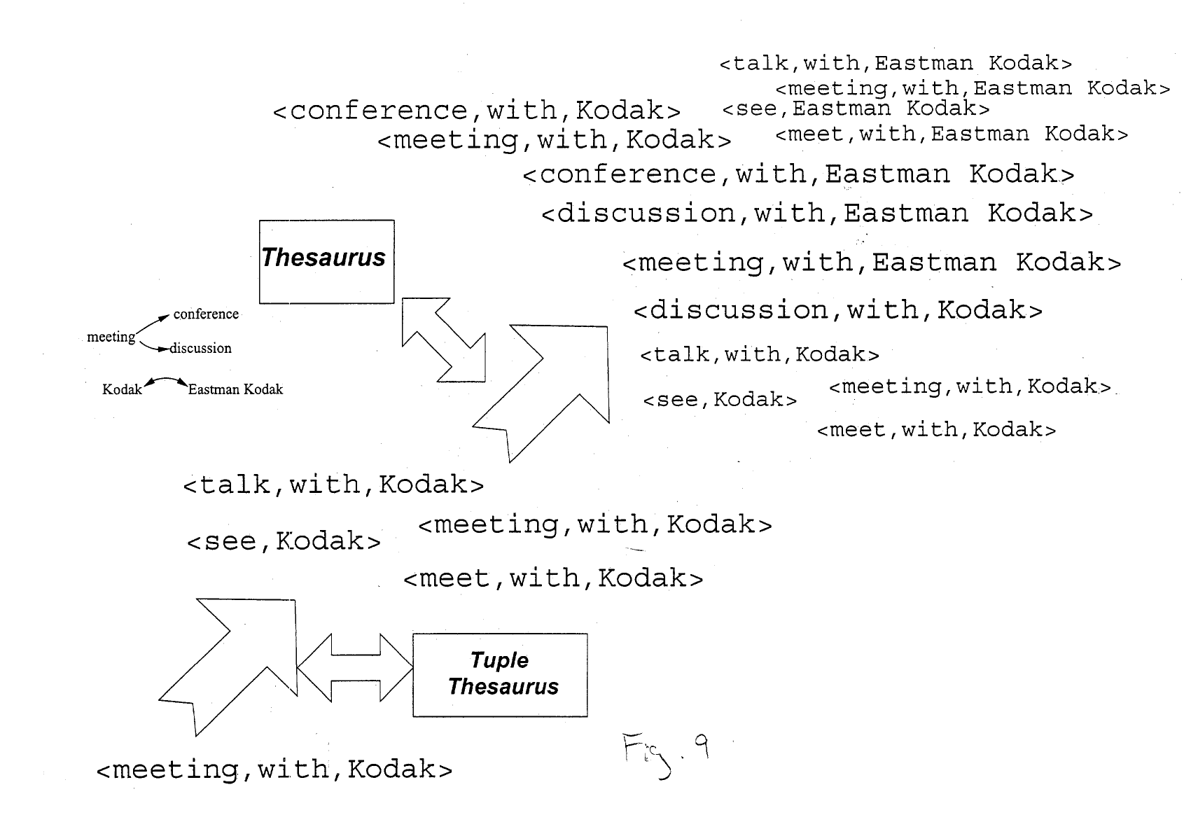

FIG. 9 is an illustration of operation of another embodiment of the keytuple expander of FIG. 1.

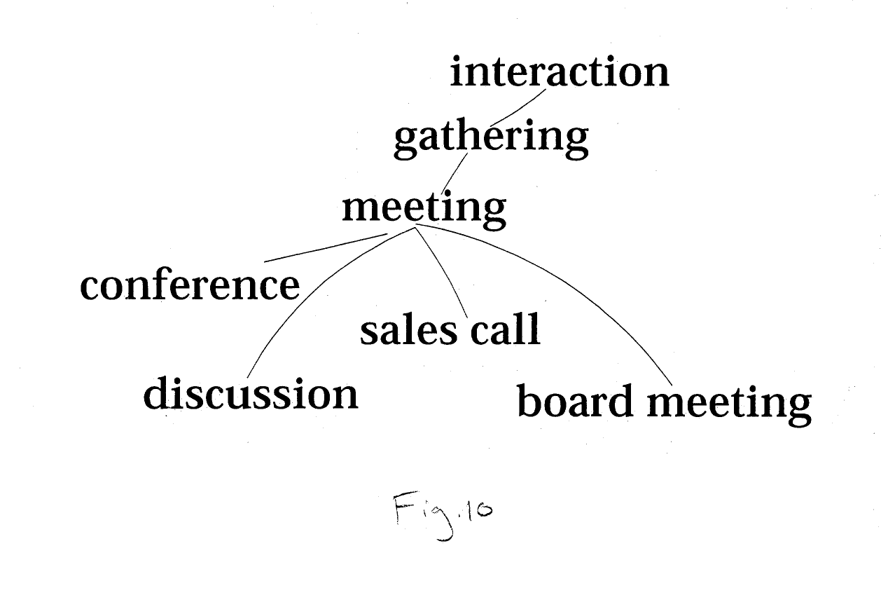

FIG. 10 is an illustration of an expansion of the word “meeting” that could be performed by one embodiment of the keytuple expander of FIG. 1.

### DETAILED DESCRIPTION OF THE INVENTION

The present invention relates to systems and methods for improving the precision and/or recall of free text natural language queries against textual databases. More generally, the present invention relates to systems and methods for managing at least one data item. For present purposes, a data item includes a document, a text fragment, and a query. Similarly, for present purposes, search data includes a text fragment and a query.

One embodiment of a system according to the invention, as depicted in FIG. 1, includes: a fragmenter 102 for breaking compound documents into fragments (typically paragraphs of their equivalent); a para-linguistic analyzer 104 for generating keytuples; a keytuple expander 106 which produces expanded keytuples using a thesaurus for both individual words and (optionally) keytuples; and an information retrieval engine 108 using any of a number of techniques for finding documents based on the similarity of textual keys. Such techniques, including Boolean retrieval, vector-space approaches, and probabilistic models typically rely on the extraction of index terms from documents. These techniques can be adapted for this application by the use of keytuples as index terms. Ricardo Baeza Yates in Modern Information Retrieval, published by Addison Wesley, 1999 and incorporated herein by reference, provides a survey of such techniques. Embodiments of this invention will also work with approaches such as Latent Semantic Indexing, where synthetic index terms are derived based on analysis of a document corpus and its actual index terms.

Three embodiments of the invention are illustrated in FIGS. 2, 3, and 4.

FIG. 2 depicts an indexing embodiment. In the indexing embodiment, a fragmenter 102 fragments documents 110 into fragments 112 and a para-linguistic analyzer 104 analyzes the fragments to extract keytuples 114. A keytuple expander 106 expands the keytuples and the system then feeds these fragments and keytuples to the information retrieval engine 108 to associate the generated keytuples with the fragments, which produced the generated keytuples.

FIG. 3 depicts a search embodiment. In the search embodiment, a para-linguistic analyzer 104 receives a query as search data and analyzes the query 116 to extract keytuples 114 and a keytuple expander 106 then expands the keytuples 114 through use of a thesaurus. The system then passes the expanded keytuples 116 to the information retrieval engine 108 to find data items, e.g., documents whose analysis produced the specified keytuples, based on the expanded keytuples.

FIG. 4 depicts a similarity embodiment. In the similarity embodiment, a para-linguistic analyzer 104 receives a text fragment as search data and analyzes the text fragment 112, coming from either a user or (more likely) an application and perhaps derived from a larger document 110, to extract keytuples which a keytuple expander then expands, as in the search embodiment. The system then passes the expanded keytuples 118 onto an information retrieval engine 108. The information retrieval engine finds data items using the expanded keytuples and passes the results to the user 120 or application that provided the original sample text.

The similarity embodiment may provide better results than the search embodiment since meaningful para-linguistic relations are more likely to be found in coherent texts than in short user-created queries.

A description of the fragmenter, the para-linguistic analyzer, the keytuple expander and the information retrieval engine now follow. Note that one may implement each of the above components in software or hardware or a combination of both.

### THE FRAGMENTER

One embodiment of the fragmenter takes large compound documents and divides them into smaller chunks for analysis and indexing. These smaller chunks can correspond to paragraphs. In one embodiment the fragmenter determines the fragments by either word processor codes or conventional separations (such as the blank lines separating paragraphs). The system uses a fragmenter because keytuples are typically more precise approximations of meaning than individual keywords and are less likely to appear outside of the discursive contexts for which they are sought.

Optionally, the fragmenter can include original positional information with generated fragments; this information indicates the original position of the fragment within the document and can be used to associate particular document locations with particular extracted keytuples. Such information, when carried along with extracted keytuples and appropriately handled by the information retrieval engine, allows the invention to identify “virtual document fragments” based on proximity and crossing the fragmentation boundaries selected by the fragmenter. For example, embodiments of the invention could identify locations where a system according to the invention extracted the keytuples <analyze,text> and <retrieve,information> within 100 characters of each other. This 100-character fragment (or a small expansion of it) is a virtual fragment created by the search process from an underlying positional representation.

### THE PARA-LINGUISTIC ANALYZER (PLA)

Robust and efficient extraction of meaning from unrestricted natural language text remains a challenge. Embodiments of the present invention can use a range of methods, which are aimed at extracting possible word relations within a text but not extracting meanings. These methods use very simple syntactic rules and perform morphological analysis on individual word forms. Ken W. Church provided one of the earliest applications of such methods in a 1980 paper entitled “On Memory Limitations in Natural Language Processing,” published in MIT Laboratory of Computer Science Technical Report MIT/LCS/TR-245, and incorporated herein by reference in its entirety. In this application, automatic analysis heuristically extracted possible triples from text. A major component of such algorithms is part-of-speech determination, using methods such as hidden Markov models as described by D. Cutting, J. Kupiec, J. Pedersen and P. Sibun in a 1992 paper entitled “A Practical Part-of-Speech Tagger” published in Proc. 3rd ANLP, Trento, Italy, between pages 133-140 and incorporated by reference herein in its entirety. Alternatively one can use hand coded methods such as those described by Eric Brill, in a 1995 paper entitled “Transformation-Based Error-Driven Learning and Natural Language Processing: A Case Study in Part of Speech Tagging, Computational Linguistics” and incorporated herein by reference in its entirety.

The purpose of the para-linguistic analyzer is not to extract unambiguous meaning or logical form, but to identify significant combinations of words from the source documents that indicate relationships and relevant context.

Para-linguistic methods explicitly over generate possible word relations to compensate for their relative lack of precision in analysis. For example, a text such as “John saw the woman in the mirror” might generate relationships <saw,in,mirror> and <woman,in,mirror> even though common sense tells the uninitiated reader that it is unlikely that the woman was “in the mirror”. However, para-linguistic analysis does not identify such subtleties and so prefers to over-generate relations, such as <woman,in,mirror> to make up for the deficient understanding.

In one embodiment a PLA begins by tagging individual words in a text with parts of speech and determining root forms. For example, as shown in FIG. 5, the PLA analyzes the sentence “Tomorrow's meetings with Kodak will be in the Rainsford Room” by determining the root forms of the words (i.e., Tomorrow, meeting, with, Kodak, will, be, in, the, Rainsford Room) and tags the root forms with parts of speech data (i.e., modifier, noun, preposition, name, auxiliary, verb, preposition, article, and name, respectively). The PLA then produces keytuples which connect adjectives to subsequent nouns and nouns to subsequent verbs.

For example, as shown in FIG. 6, the PLA couples a modifier (tomorrow) with a neighboring noun (meeting). Similarly, the PLA couples a noun (meeting) with a neighboring preposition (with) and name (Kodak) and couples a name (Kodak) with a preposition (in) and another name (Rainsford Room). The PLA also connects nouns and verbs to prepositional arguments and their objects. In different languages, these simple rules would be different and special cases might apply.

In one implemented embodiment, the general procedure for para-linguistic analysis has the following structure:

1. Break the input fragment K into a vector of words W[i]

2. Determine the likely parts of search P[i] and linguistic root forms R[i] for each W[i]

3. For each W[i]:

a. If P[i] is ‘adjective’, find the next W[j](j>i) such that P[j] is ‘noun’ and record the tuple <R[i],R[j]>.

b. If P[I] is ‘verb’, then find the closest preceding W[j] (j<I) for which P[j] is ‘noun’ and record the tuple <R[j],R[i]>.

c. If P[I] is ‘preposition’ then find the next W[j] such that P[j] is ‘noun’ and then record the tuple <W[i],R[j]> and iterate over the preceding words W[k] (k<i):

i. If P[k] is ‘noun’ record the tuple <R[k],W[I],R[j]>

ii. If P[k] is ‘verb’ record the tuple <R[k],W[I],R[j]> and exit the iteration (c)

Many other implementations are possible with the same general logical structure.

For example, FIG. 7 depicts a special case for English where the PLA handles the passive construction to produce a keytuple that reflects the object-verb-by-subject structure of the English passive. More specifically, the PLA analyzes the sentence “the public presentations will be followed by cocktails” to determine root forms and to tag the root forms (i.e., the, public, presentation, will, be, followed, by, cocktail) with parts of speech data (i.e., article, modifier, noun, auxiliary, be, verb, preposition, and noun, respectively). Next, the PLA applied in an English context uses conventional techniques to determine that the sentence is in the passive voice. Given that the sentence is in the passive voice, the PLA constructs a keytuple, i.e., <cocktail, follow, presentation>, which reflects the object-verb-by-subject structure of the English passive.

Note that in this embodiment, the PLA treats certain compound nouns and proper names as single lexical tokens, so that the PLA analyzes “Rainsford Room” as a single word and relates the phrase to other words as a unit.

While the above-described PLA is one embodiment, one can construct another embodiment of a PLA by analysis of a large corpus and by the extraction of word pairs that commonly co-occur within some distance of each other; simple para-linguistic analysis would then consist of filtering a text for such common word pairs.

Finally, the PLA may use the optional positional information provided by the fragmenter to associated a text document position with each keytuple. This text document position would be passed through the keytuple expander and then onto the information retrieval engine.

### THE KEYTUPLE EXPANDER (KE)

There are different embodiments of the KE. In a lexical mode, the KE expands an arbitrary keytuple by expanding the individual words within the keytuple to synonymous words looked up in a thesaurus to create sets of synonyms and then creates a set of keytuples that typically include at most one synonym from each of the sets of synonyms. FIG. 8 illustrates the lexical mode. The keytuple is <meeting, with, Kodak>. The KE expands the word “meeting” to include synonyms “conference” and “discussion” and the word “Kodak” to include synonym “Eastman Kodak.” The KE then creates a set of keytuples that typically include at most one synonym from each of the sets of synonyms, e.g., <discussion, with, Eastman Kodak>, <conference, with, Eastman Kodak>, and <conference, with, Kodak>.

In a inference mdoe, the KE can use a keytuple thesaurus to expand particular keytuples in particular ways. FIG. 9 illustrates the inference mdoe, combined with the lexical mode of FIG. 8. First the KE expands the keytuple <meeting, with, Kodak> using a tuple thesaurus to obtain a first set of keytuples: <talk, with, Kodak>, <see, Kodak>, <meeting, with, Kodak>, and <meet, with, Kodak>. Then the KE applies the lexical mode to at least part of the first set of keytuples to obtain a second set of keytuples. In other words, for each subject keytuple from the first set of keytuples, the KE expands the keytuple by expanding the individual words within the keytuple to synonymous words looked up in a thesaurus to create sets of synonyms and then creates a second set of keytuples in which each keytuple in the second set of keytuples typically includes at most one synonym from each of the sets of synonyms.

One design choice in lexical mode involves the character of the thesaurus and how it is used. As shown in FIG. 10, a word like ‘meeting’ may have no direct synonyms but may have near synonyms which have a more precise meaning, e.g., conference, sales call, or board meeting, or a more general meaning, e.g., interaction, gathering, or discussion. For example, in a trip report from a sales representative, meeting can often be taken as meaning “sales call”. Likewise, searches on databases of business transactions are unlikely to include the sense of “meeting” which includes religious revivals or services. For different situations or applications, or when analyzing documents from different sources, different thesauri may be applied in the expansion. The latter case demonstrates how the range in which the expansion occurs may also be subject to the genre and character of the database being searched. For example, some synonyms may only apply to word meanings outside of the scope of the database and the use of these synonyms in expansions will be either irrelevant (the expansions are not found) or erroneous (the expansions get the wrong meaning despite the contextual information of the tuple). Considerations of genre and character can directly effect search results. For example, when searching a collection of databases for the compound noun “sales calls,” searches of sales representative trip reports could expand to the word “meetings”. Likewise, searches on the same databases for meetings would not be expanded to the term “services” (as it might in a pastoral religious genre).

The rules for expanding keytuples may reflect the structure or tagging information, i.e., the parts-of-speech data, attached to the keytuple. For instance, the KE, when expanding the triple <‘meet’,‘in’,‘Paris’> might not expand the preposition ‘in’. The rules used by the KE may also include language-specific semantic preferences, so that the KE might expand <‘shot’,‘at’,?> into <‘fire’,‘at’,?> but not <‘photograph’,‘at’,‘?’>. Such rules are necessarily language specific and may also be part of the specific application of the invention to a language and domain. For example, applied to a domain of surgical reports, the term ‘separate’ might be expanded to include ‘cut,’ but this expansion would be inappropriate in most everyday domains.

The inference mdoe of the KE provides for two related functions.

First, certain keytuples strongly indicate meanings of words that might license wider expansion than would otherwise be wise. There are no general criteria for identifying such keytuples but the class of criteria can often be organized around particular patterns of verb or noun usage. One can look at how a verb like “light” determines that its argument can be expanded more aggressively than typical for any verb. This license for expansion could be limited, at the same time, to certain categories and kinds of relations among synonyms, near-synonyms, or otherwise associated terms. For example, a tuple such as <‘light’,‘fire’> might be readily expanded into <‘light’,‘flame’> even if the default expansion rules of lexical mode might rule out the expansion.

Second, the inference mdoe of the keytuple expander provides a certain inferential component to the search process. For example, a tuple like <‘fire’,‘gun’> can expand into a tuple like <‘pull’,‘trigger’>, indicating a relationship, which is not an equivalence of meaning but an inference of circumstance. Such an inference of circumstance is related to the use of inference networks in information retrieval to expand from particular keywords or keyword combinations to other keywords. H. Turtle and W. Croft in a 1991 paper entitled “Evaluation of inference network-based retrieval methods” published in ACM Transactions on Information Systems, 9(3):187-222 and incorporated herein by reference in its entirety discusses the use of inference networks. In the case of embodiments of the present invention, however, keytuples provide for a more reliable and robust expansion than do keywords.

The table used in inference mdoe of the keytuple expander can be constructed either by hand or by statistical methods over a corpus of texts. Commonly co-occurring keytuples can be entered into this table, as can keytuples that do no co-occur with each other but repeatedly co-occur with the other similar keytuples. Various methods of textual data mining, statistical analysis, and automated thesaurus creation, normally applied to individual keywords or co-occurring keyword pairs, can be applied to keytuples in order to create this table. One approach to such generation is discussed by Gregory Grefenstette in his 1993 University of Pittsburgh PhD thesis entitled “Automatic Thesaurus Discovery Via Selective Natural Language Processing: A Corpus Based Approach” and incorporated herein by reference in its entirety.

One embodiment of the structure of a process employed by the keytuple expander is shown in FIGS. 8 and 9.

### THE RETRIEVAL ENGINE

The retrieval engine may use a variety of different algorithms and methods developed over decades of research on information retrieval systems. The key function of the retrieval engine is to take a set of “search keys” and return a set of documents based on those keys. This function may be implemented in numerous ways to reflect the varying degrees of importance of particular search keys either in general or with respect to a particular document.

One embodiment of the retrieval engine is an engine that employs the vector space method (discussed above). In this method, documents, fragments, and/or queries are represented by large sparse vectors where each component in the vector corresponds to a particular keytuple and the components contain zero if the document or query doesn't contain the keytuple (thus the vectors are always sparse) and contains 1 or a weight (possibly based on other criteria) if the keytuple has been generated by analysis and expansion from the document, fragment, or query. A common criterion for determining the weight is the frequency of a term, either within a document or within the entire corpus, or their combination. For instance, one standard metric is to weigh the term by the product of the term frequency (typically normalized to account for document size) and the inverse document frequency (how many documents contain the term, again typically normalized with respect to the number of terms and scaled logarithmically). This takes into account the greater prominence of common terms within a document and the typically lower discriminative utility of terms that occur frequently across documents.

One version of the vector space method that can be used is the “cosine method” which compares queries and documents by measuring the angle (in a very high dimensional space) between their vectors. The cosine method has been used extensively in information retrieval where the vector elements correspond to keywords. The sparse vectors for keytuples are much larger and sparser than for keywords. On the other hand, because keytuples are much less likely to occur multiple times in a document, weighting calculations can sometimes avoid tracking term frequency within a document.

There are numerous other methods and metrics which can be applied in the information retrieval engine. Nearly any retrieval method that functions for keywords can be extended to apply to keytuples, However, the implementation of these methods typically requires additional optimizations and modified data structures to deal with the fact that the space of possible keytuples is much larger than the space of possible keywords. For example, many modern implementations of vector space methods rely on manipulating compact vectors in physical memory where terms are associated with particular vector position or index. Thus, a word like “fire” may be associated with the index 373 (for instance) in a number of tables describing documents and the corpus as a whole. This is feasible where the number of terms may only run into the tens of thousands, but is infeasible with keytuples, where the number of terms may run into the millions. Alternative optimizations, such as using hash tables or tree structures, must then replace the position-indexed tables of keyword-based approaches. This is indicative of the kinds of adaptations, which must be made to conventional keyword-driven information retrieval algorithms in order to function efficiently and effectively with keytuples.

Embodiments of the information retrieval engine associate a text fragment or text fragment identifier with a set of key terms, which are keytuples extracted and expanded from the fragment. One embodiment of the information retrieval engine, given a set of terms, returns and ranks documents based on similarity of the sets of analyzed key terms. In the case, where the embodiment uses original positional information, it should also be able to associate such terms with documents and positions and return derived terms occurring near one another in particular documents.

Having thus described at least one illustrative embodiment of the invention, various alterations, modifications and improvements are contemplated by the invention including the following: the addition of keytuple expansion rules by dynamic learning and user instruction; the analysis of the statistical inter-dependency of keytuples in comparing keytuple descriptions; and the expansion of keytuples across natural languages to support inter-lingual text searching. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A system for managing at least one data item, the system comprising:
a para-linguistic analyzer operative to receive search data and to identify a first keytuple included in the search'data;
a keytuple expander in communication with the para-linguistic analyzer and operative to generate a set of keytuples associated with the first keytuple; and
an information retrieval engine in communication with the keytuple expander and operative to manage at least one data item based at least in part on the set of keytuples.

2. The system of claim 1 wherein the system further comprises:
a fragmenter in communication with the para-linguistic analyzer and operative to receive documents and to separate the documents into a plurality of fragments, wherein the para-linguistic analyzer is operative to use a first fragment from the plurality of fragments as search data, and wherein the information retrieval engine associates the set of keytuples with the first fragment.

3. The system of claim 2 wherein the plurality of fragments are paragraphs.

4. The system of claim 1 wherein the search data is a query and wherein the information retrieval engine is operative to rank data items by comparing keytuple sets associated with data items with keytuple sets associated with the query.

5. The system of claim 1 wherein the search data is a text fragment and wherein the information retrieval engine is operative to rank data items by comparing keytuple sets associated with data items with keytuple sets associated with the query.

6. The system of claim 1 wherein the first keytuple is a pair of words with linguistic significance to the search data.

7. The system of claim 1 wherein the first keytuple is three words with linguistic significance to the search data.

8. A method for managing at least one data item, the method comprising:
receiving search data;
identifying a first keytuple included in the search data;
generating a set of keytuples associated with the first keytuple; and
managing at least one data item based at least in part on the set of keytuples.

9. The method of claim 8 wherein receiving search data comprises:
receiving a document;
separating the document into a plurality of text fragments; and
using a first text fragment from the plurality of text fragments as the search data.

10. The method of claim 9 wherein the text fragments are paragraphs.

11. The method of claim 9 wherein managing at least one data item comprises associating the generated set of keytuples with the first text fragment.

12. The method of claim 8 wherein the search data is a text fragment.

13. The method of claim 8 wherein identifying a first keytuple comprises identifying a plurality of first keytuples and wherein generating a set of keytuples comprises generating a set of keytuples for each of the plurality of first keytuples.

14. The method of claim 8 wherein the search data is text and wherein identifying the first keytuple comprises:
associating words in the text with parts-of-speech data;
determining root forms of words in the text; and
connecting the root forms of words based on the parts-of-speech data associated with the words.

15. The method of claim 8 wherein a keytuple is a plurality of words with linguistic significance to the search data.

16. The method of claim 15 wherein generating a set of keytuples comprises expanding the words of the keytuple to natural language synonyms.

17. The method of claim 15 wherein generating a set of keytuples comprises:
expanding the first keytuple to keytuple synonyms to create a first set of keytuples; and
expanding the words of each of the keytuples in the first set of keytuples to natural language synonyms to create a second set of keytuples.

18. The method of claim 8 wherein the search data is a query and wherein managing a data item comprises:
ranking a set of data items by comparing keytuple sets associated with data items with keytuple sets associated with the query.

19. The method of claim 8 wherein the search data is a fragment and wherein managing a data item comprises:
ranking a set of data items by comparing keytuple sets associated with data items with keytuple sets associated with the fragment.

20. A system for managing at least one data item, the system comprising:
para-linguistic analyzer means for receiving search data and for identifying a first keytuple included in the search data;
keytuple expander means in communication with the para-linguistic analyzer means, the keytuple expander means for generating a set of keytuples associated with the first keytuple; and
information retrieval means in communication with the keytuple expander means, the information retrieval means for managing at least one data item based at least in part on the set of keytuples.
